(19) United States
(12) Patent Application Publication
(10) Pub. No.: US 2005/0278206 A1
(43) Pub. Date: Dec. 15, 2005

(54) Method and system for scheduling organization

(76) Inventors: Brian Choper, College Park, MD (US); Rafael Javadov, Cockeysville, MD (US)

Correspondence Address: Rochelle Lieberman, Esq.;Lieberman & Brandsdorfer, LLC, 12221 McDonald Chapel Drive, Gaithersburg, MD, 20878-2252, US

(21) Appl. No.: 10/867,451

(22) Filed: Jun. 14, 2004

(51) Int. Cl. G06F 17/60

(52) U.S. Cl. 705/8

(57) ABSTRACT

A method and system for efficiently and effectively scheduling contractors for participation in a contract. All communications between the contractors and a manager can be accomplished electronically, and all contract details can be provided electronically. The contract details are accessible through a global computer network. Acceptance of a subcontract by a group member may also include a legal agreement outlining the terms and conditions therewith. Upon acceptance of the subcontract by a member, an electronic message is forwarded to the member with a link to a site containing contract details. In the event of a change associated with the contract, the member will receive an additional electronic message with a link to a site containing all changes to the contract. The site is accessible through a global computer network.

### BACKGROUND OF THE INVENTION

1. Technical Field

This invention relates to a method and system for organizing and scheduling contractors for a work order. More specifically, the invention includes a scheduler that is accessible by the contractors through a global communication network.

2. Description Of The Prior Art

As a means for effective organization, businesses and agencies are constantly searching for improved methods of creating schedules based on their client's needs and, when necessary, obtaining the appropriate employees or subcontractors to fit within these schedules. The ever increasing access to the internet facilitates these methods by increasing the speed in which an agency can make a customer's schedule available electronically and by increasing the efficiency in contacting appropriate employees or subcontractors.

The technology in U.S. patent Publication 2003/0028410 to House et al. affords organizations the opportunity to manage their scheduling needs internally through the use of a wireless intranet. In this publication, a service manager in need of employee support for a job requests such support, via a wireless intranet, through the organization's Human Relations Division (HR). Following the request, HR manually searches the company's database to identify personnel qualified to perform a task associated with the support and identifies the availability of such personnel. If the personnel are available, HR assigns the job to the designated personnel and, via the wireless intranet, notifies a service manager of the job's assignment. However, this publication is limited to use internally from within a private intranet as there is no consideration for applying this schedule management for use over a global computer network. Accordingly, there are limitations in House et al.'s communication and schedule organization.

In U.S. patent Publication 2003/0154116 to Lofton, a schedule is posted over a global computer network and multiple users within an agency are given access to the schedule. The accessibility of the schedule by multiple parties simplified the costs of planning. Users of the schedule are allowed to notify and coordinate their availability for an event over the global computer network. In comparison to the above Publication to House et al., the geographic location of each user is not confined within the physical agency locale. However, this publication is limited in it's application as it only contemplates schedule coordination from within a family environment and is not expressly applied to a business setting.

In U.S. patent Publication 2003/0139962 to Nobrega et al., a customer electronically submits to an agency a work request through a global computer network. In response, the agency creates a schedule that compliments a client's work request and posts this schedule on the network. Following creation of the schedule, a subcontractor profile list is used to obtain potential subcontractors that are qualified to perform tasks within the parameter of the schedule. Qualified subcontractors are then notified through a global computer network based messaging system that there is a job available through the agency. The notification provides a link to the website where the job information is posted. Based on the information posted, the subcontractor can determine if they are available to pursue the job and can electronically reply to the agency to accept or reject the offer. However, there are several limitations to this art. For example, a problem arises when the agency creates a customer schedule that necessitates more than one type of subcontractor. In Nobrega et al., the client typically requires a single subcontractor for a single work request. The agency is limited to notifying one subcontractor in a specific category of the job opening. However, if the customer is scheduling an event that would require a multitude of subcontractors with similar or dissimilar skills to work concurrently or consecutively in the event, the prior related art requires a repetition of the above steps for each category of the subcontractors. Repeating the subcontractor notification for each category can become cumbersome for use in large scale event planning that involves a large number of subcontractors. Accordingly, Nobrega et al. is tailored to a limited skill set and small scale planning and small job requests.

There is therefore a need for a product that enables schedule management for a contract requiring participant having similar and/or dissimilar skills.

### SUMMARY OF THE INVENTION

This invention comprises a method and system for scheduling contractors with diverse skills in a single workflow.

In one aspect of the invention, a scheduling method is provided for organizing a hierarchy, with a manager and a group of members. The manager is assigned to a first group of members. A schedule is received from a third party. Upon authorization of the schedule by the manager, an announcement of the event is transmitted to the first group of members. The announcement should include limited details pertaining to the event. In addition, an acceptance response to the announcement legally binds the member to the event.

In another aspect of the invention a scheduling system is provided. The system includes a hierarchical organization having a group of members, with a manager assigned to the group. A schedule for an event is received by the manager. Upon authorization of the schedule by the manager, an announcement with limited event details is transmitted to a first selection of members. In addition, a legal agreement is associated with an acceptance response to the announcement.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a hierarchical organization of the manager and the members of the group.

FIG. 2 is a flow diagram illustrating the process of a manager scheduling members of the group according to the preferred embodiment of this invention, and is suggested for printing on the first page of the issued patent.

FIG. 3 is a flow diagram illustrating the process of a group member responding to an announcement.

### DESCRIPTION OF THE PREFERRED EMBODIMENT

### Overview

The system and method is developed to facilitate the subcontracting of certain skilled individuals for participation in a third party event through the use of a global computer network. The system and method employs a hierarchy consisting of a manager and members, wherein the members have skills that are similar and/or dissimilar. The manager determines which skilled group members are suited for participation in the event and announces the event to these members. Each member is given an opportunity to respond to the announcement. If the group member accepts an invitation to an event, they become legally bound to participate at the event. However, if the group member declines the invitation, the manager announces the event to another members within the skilled group until all the needs of the event are met. After accepting, each group member is given a link to a web based job description site providing expanded details of the event. The manager updates all participating members of any changes to the event through notification and amendments to the job description site.

### Technical Background

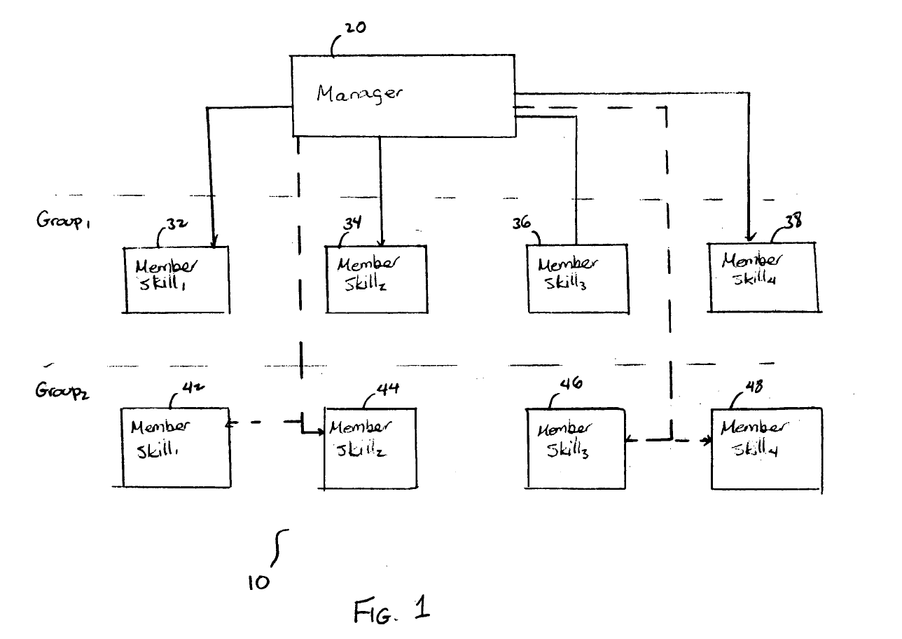

FIG. 1 (10) is a block diagram illustrating a hierarchical chart of an organization from the organization's perspective. The first block (20) represents a manager within the organization. The remaining blocks (32, 34, 36, 38), are subordinate to the manager, with each block in communication with the manager. Each block represents a member of the organization, wherein each member possesses a certain skill relevant for the manager to use when scheduling events. The first level of blocks is a first group of members that are preferable for selection for a specific event. Each of the blocks (32, 34, 36, 38 ) may represent a separate and distinct skill, or there may be overlapping skills among the members of the first group. The manager (30) is in communication with each skill block (32, 34,36,38) denoting placement of the manager into a supervisory position relative to each skill group. Following the first group of members, there is a second group of members (42, 44, 46, 48). Similar to the first group, each block in the second group represents members of the organization wherein each member possesses a certain skill. The manager is in communication with each of the members of the second group, similar to the members of the first group. The differences between the two groups is the preference by the manager for contracting for specific events. As shown in detail below the hierarchical organization of the members enables the manager to select members for specific events based upon skills, availability, and response received from an announcement. Although the organization chart shown herein only has two groups of members with four members in each group, the quantity of groups as well as the members assigned to each group may vary depending upon the structure of the organization and the quantity of members and skills required for different events. Accordingly, the organization structure shows the relationship of the manager to the members, as well as the communication channels between the manager and the members of the groups.

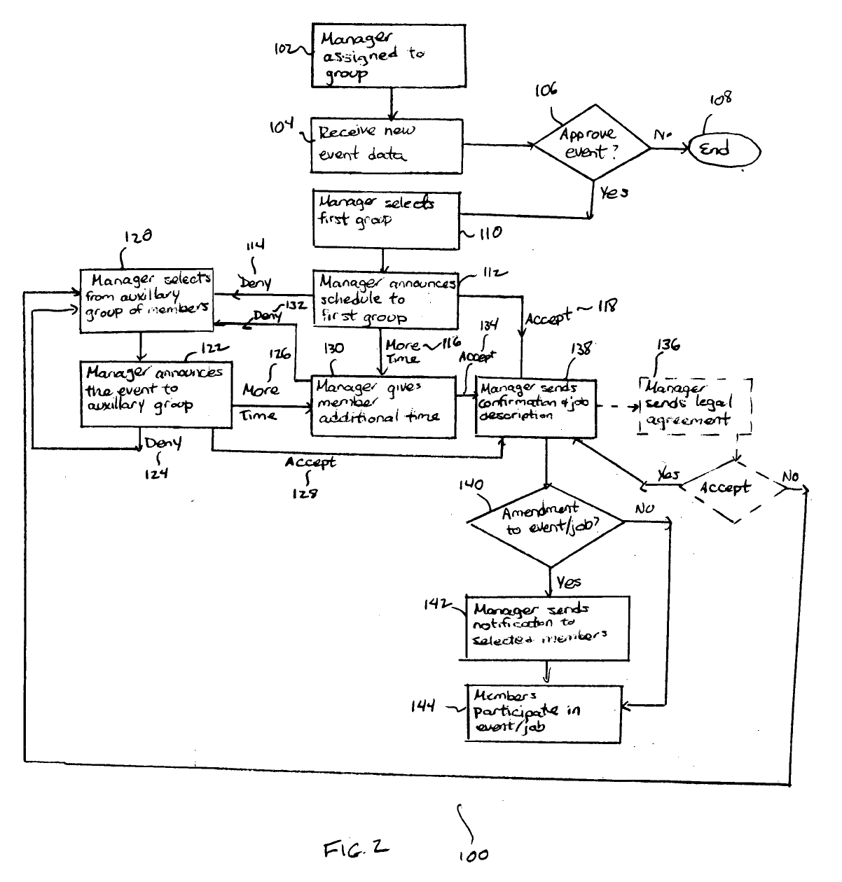

FIG. 2 is a flow chart (100) detailing sequential steps the manager takes to plan and subcontract certain members of certain specified skill groups for a third-party event. The first block (102) represents the assignment of the manager to the skilled groups and establishment of the hierarchy depicted in FIG. 1. The next step (104) is the manager's receipt of new event data. From this data, the manager is able to determine a myriad of information regarding the schedule of the event and skills required for the event. The manager then decides whether to approve the event and accept the schedule (106). The manager's decision is based upon details of the event data such as whether the members of the skill groups are previously committed to another contract, whether the members of the skill groups possess the talent required from the contract, and the price and profitability associated with the contract. If the manager does not approve the event, the scheduling process is terminated (108). However, if the manager does approve the event and a contract associated therewith, the manager then turns to his assigned members and associated grouping of the members for selection of a first group members with skills to meet the skill needs of the event (110). Group selection is based upon event terms and conditions, as well as skills or the organization members. In addition to the first group of members, the manager selects other members in secondary and other groups of the organization for placement in the organization hierarchy for the associated event(s). Accordingly, the first part of the scheduling process includes review of the contract and organization of members into groups dependent upon the requirements of the contract and skills of the members.

Following approval of the contract and terms therein, the manager selects a first group of members to receive an announcement of a subcontract. The manager then forwards a message to members of the first group with subcontract information (112). The message contains basic information regarding the subcontract and allows the recipient first group members to individually select to respond to the message with the following options: decline the subcontract (114), request more time to decide whether to accept (116), or accept the subcontract (118). Should any of the first group of members decline the subcontract (114), the manager may then return to his assigned skill groups to select from a second group of members to replace the first group members who have declined the subcontract (120). The manager then announces the subcontract to selected members of the second group for participation in the subcontract (122). Similar to the first group's message, the second group's message contains basic information regarding the subcontract and allows the recipient second group members to individually respond to the message with the following options: decline (124), request more time to decide (126), or accept (128) the subcontract. If the manager receives a response from any of the second group members declining the subcontract (124), the manager may then return to selecting from a third group of members to participate in the subcontract (120). This process may continue until the manager receives a satisfactory number of accept responses from selected group members to fulfill the requirements of the contract.

The first group members and additional group members who receive the announcement of the event also have the option to request more time to decide (116, 126) whether or not they are available or interesting in accepting the subcontract. Selection of this option in the message by the group member notifies the manager of their request (130). After the time requested, the group member may then decline the subcontract associated with the announcement (132) or accept it (134). Should the group member decline the subcontract (132), the manager returns to the steps mentioned above in selecting and announcing the subcontract to additional group members (120).

Finally, any member of any group who has received and accepted the subcontract associated with the announcement will be legally bound to the terms of the subcontract. The legal agreement may occur upon an acceptance by each member, or the legal agreement may occur following the initial acceptance and upon receiving further subcontract details (136). Once enough accept responses have been received the manager sends a confirmation to the group members for their participation in the event (138) in a computer readable medium. However, if a group member decline acceptance of a legal agreement, the manager may return to step (120). The confirmation contains a link to a site with subcontract information details (138). If there was no legal agreement at step (136), the link at step (138) may include a legal agreement. In addition, if there are any future amendments to the subcontract (140), the electronic site associated with the link is updated with such amendments, followed by an electronic message sent to each of the group members who had previously accepted the subcontract notifying them of the changes (142) prior to participation in the event (144). Accordingly, the schedule functions as a communication tool between a manager and a group of contractors.

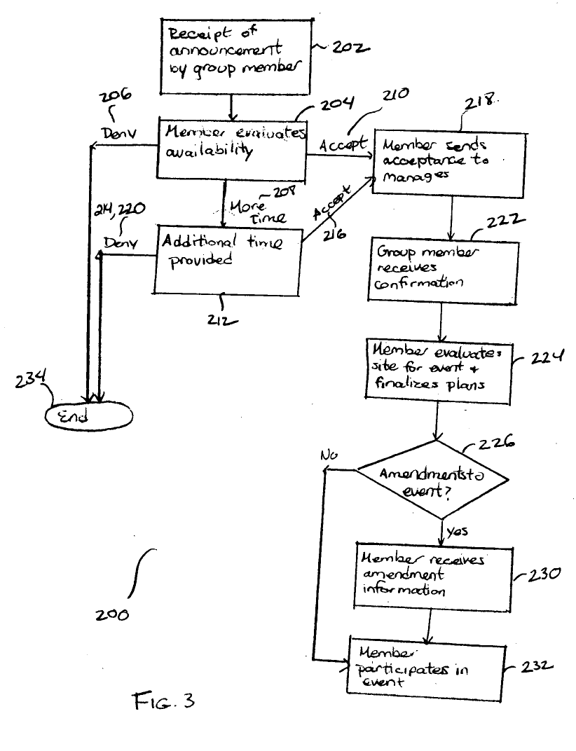

FIG. 3 (200) represents the steps in scheduling the event from the perspective of the group members. First, the group member receives the announcement of the event from the manager (202). Based on the brief description of the job, the group member then evaluates their availability on the event date (204) and selects from one of three options on the announcement: decline (206), request for more tine (208), or accept (210). If the group member declines the announcement (206), then their involvement with the event ends (234). If the group member requests more time (208), they may be afforded more time by the manager to evaluate their availability for the event (212). Note, there is a time limit set by the manager to respond to each event announcement. If the manager does not receive an acceptance or rejection to the announcement to the group member(s) who requested more time within a predefined time interval, those members will receive an electronic message reminding them of the duty to respond. After the end of the predefined time interval, lack of a response will be interpreted as a decline. If the group member decides that they are unavailable for the event, then the group member declines the announcement (214, 220) and their involvement with the event ends (234). Finally, the group member may select to accept (210, 216) the event announcement by sending an accept response (218), which is forwarded to the manager.

Following the step of acceptance of the subcontract, each group member will receive a confirmation communication with a link to a job description site that contains details for the event (222). Based on this site, the group member will finalize their planning for the event (224). If there are no changes to the subcontract and associated terms (226), the group member will participate in the event as originally scheduled (232). However, if changes are made to the subcontract, the group members will be notified by an electronic communication that a change was made to the subcontract and associated detail(s) (230). The electronic communication will include a link to a site on a global computer network detailing the changes to the subcontract, and how it may affect one or more of the group members. The group member(s) should review the site and makes appropriate adjustments in their planning (232). Accordingly, all communication between the manager and members is conducted electronically with an electronic link to a site containing details and/or amendments to the subcontract.

### Advantages Over The Prior Art

The present system and method is similar to the prior art in that a form of scheduling is able to be conducted via a global communication network and a schedule for an event is able to be posted on the network and viewed by multiple users with little geographic limitation. Furthermore, the present system and method, similar to the prior art, provides a means for an agency to notify a subcontractor of a job through a global communication messaging system and allows the agency to receive a response from the subcontractor through the same system. However, the present system and method distinguishes itself from the prior art in that it allows a single agency to subcontract multiple parties for a single event. Unlike the prior art, the agency is not constrained to a single skill group for a single job. In the present system and method, the agency is able to contract a large event requiring multiple skill groups and efficiently able to subcontract individual skill groups concurrently with an electronic messaging system. All event details are placed in a central location accessible by all members who have accepted the subcontract. In the event of a change to the subcontract, the change is placed in the central location, and an electronic message is sent to all members of the group who accepted the subcontract notifying them of a change and providing each of the members an electronic link to the site.

### Alternative Embodiments

It will be appreciated that, although specific embodiments of the invention have been described herein for purposes of illustration, various modifications may be made without departing from the spirit and scope of the invention. In particular, the legal agreement between the manager and contractor may take place upon acceptance or anytime thereafter. The subcontractor will be provided with the legal agreement in electronic format. Acceptance of the agreement will be a required step for acceptance of the contract. In addition, each group member may be assigned a code identify the member. Upon acceptance of the contract, the group member may be required to enter their identifying code as verification. Furthermore, the group members include band members, party planners, photographers, decorators (etc.), and general contractors. In another embodiment, the site containing details of the event may include a confirmation key. Acceptance of the key will cause an electronic message to be sent to the manager notifying the manager that the member has reviewed the site with the event details. Similarly, an amendment to the site may also include an accept key. When the member has review the site and accepted the changes, an electronic communication is forwarded to the manager. The electronic communication functions as a notification system, and minimizes the need for further communications between any of the group members and the manager. Accordingly, the scope of protection of this invention is limited only by the following claims and their equivalents.

1. A scheduling method comprising:
a) organizing a hierarchy having a manager and a subordinate group of members;
b) assigning said manager to a first group of members;
c) receiving a schedule for an event from a third party;
d) authorizing the said schedule for the event by said manager;
e) selecting said first group of members for participation in said event;
f) transmitting an announcement of said event to said selected members, wherein the announcement includes limited details of said event; and
g) legally binding a member associated with an acceptance response to said announcement of said event.

2. The method of claim 1, wherein selecting said first group members for receipt of said announcement is performed by evaluating the skills of said members as similar or dissimilar to the needs of said event.

3. The method of claim 2, wherein said first group members are skilled as: musicians, entertainers, sound technicians, caterers, event coordinators, party decorators, photographers, general contractors having similar skills, general contractors having dissimilar skills, or combinations thereof.

4. The method of claim 1, further comprising requiring a response for said event announcement.

5. The method of claim 4, wherein said first group member must choose between the options accept, decline, and extra-time request contained within the required response field.

6. The method of claim 1, further comprising confirming acceptance of said event announcement from said manager in response to receipt of an accept response to said initial announcement from at least one of said members of said first group.

7. The method of claim 6, wherein the step of confirming acceptance of said event includes at least one of said members of said first group receiving an electronic communication with a link to an event detail site.

8. The method of claim 1, further comprising notifying all members of said group who provide an accept response to said event announcement of an amendment to details of said event.

9. The method of claim 8, wherein the step of notifying all members of said group includes an electronic message with a link to an event detail site.

10. The method of claim 9, wherein said link is accessible through a global computer network.

11. The method of claim 1, further comprising selecting a second group of members for said event announcement following a decline response from at least one of said members of said first group.

12. The method of claim 1, wherein the step of legally binding a member to said event includes said member providing a verification code for identifying said member to said manager.

13. A scheduling system comprising:
a. a hierarchical organization having a group of members and a manager assigned to said group of members:
b. a schedule for an event received by said manager, wherein said schedule is adapted to be authorized by said manager;
c. an announcement adapted to include limited event details and further adapted to be transmitted to a first member selection; and
d. a legal agreement adapted to be associated with an acceptance response to said announcement from at least one of said members and said manager.

14. The system of claim 13, wherein said selection includes an evaluation of skills of said individual with respect to required skills for said event.

15. The system of claim 14, wherein said members are skilled as: musicians, entertainers, sound technicians, caterers, event coordinators, party decorators, photographers, contractors with similar skills, contractors with dissimilar skills, or combinations thereof.

16. The system of claim 13, further comprising a required response field in said announcement.

17. The system of claim 16, wherein said required response field includes a response selected from a group consisting of: accept, decline, and extra-time request.

18. The system of claim 17, wherein said accept response includes said legal agreement between a member and said manager.

19. The system of claim 13, further comprising a confirmation communication adapted to be sent to a member of said first member selection who responded to said announcement with an acceptance.

20. The system of claim 19, wherein said confirmation communication includes an electronic link to an event detail site.

21. The system of claim 13, further comprising a communication of an amendments in said event detail adapted for delivery to all members of said group who affirmatively respond to said event announcement.

22. The system of claim 21, wherein said amendment communication includes an electronic message with a link to an event detail site.

23. The system of claim 22, wherein said link is accessible through a global computer network.
